(19) United States
(12) Patent Application Publication
(10) Pub. No.: US 2022/0398642 A1
(43) Pub. Date: Dec. 15, 2022

(54) SYSTEMS AND METHODS FOR PRODUCT RELEVANCY IN A PRODUCT DISTRIBUTION SYSTEM

(71) Applicant: BEP Borrower HoldCo, LLC, Waltham, MA (US)

(72) Inventors: Joshua TACKETT, West Palm Beach, FL (US); John B. DAVIE, Lantana, FL (US)

(21) Appl. No.: 17/836,667

(22) Filed: Jun. 9, 2022

Related U.S. Application Data
(60) Provisional application No. 63/208,872, filed on Jun. 9, 2021.

(51) Int. Cl. G06Q 30/06; G06Q 30/02

(52) U.S. Cl. CPC G06Q 30/0629; G06Q 30/0234

(57) ABSTRACT

Systems and methods for product relevancy may include a system for determining matching products, including a memory storing instructions and one or more processors coupled with the memory. The one or more processors are configured to: receive, from a user terminal, food product information; transform the food product information into normalized food product information according to a normalized format of a food distribution system; determine a product corresponding to the normalized food product information, wherein the product is associated with one or more normalized first product characteristics; identify a matching product that corresponds to the product based at least on overlap between the one or more normalized first product characteristics and one or more normalized matching product characteristics associated with the matching product; and transmit, to the user terminal, a notification of the matching product.

### CROSS REFERENCE TO RELATED APPLICATIONS

The current application claims priority to, and the benefit of, U.S. Provisional Application No. 63/208,872 filed Jun. 9, 2021 and entitled “SYSTEMS AND METHODS FOR PRODUCT RELEVANCY IN A PRODUCT DISTRIBUTION SYSTEM,” the contents of the which are hereby incorporated by reference in their entireties.

### TECHNICAL FIELD

Aspects of the present disclosure relate generally to systems that identify products, and more particularly, to systems and methods for providing product relevancy for determining matching products.

### BACKGROUND

There are often difficulties in finding similar products when searching a computing system, such as a distributor website, as often products from different sources have different names and/or descriptions. In one example, which should not be construed as limiting, conventionally, foodservice operators (e.g., restaurants, foodservice providers) that purchase food products need to manually search food distributor (or food manufacturer) inventories to find and order food products. Different descriptions of the food products are often provided for similar food products by different distributors resulting in an excessive amount of time being spent on searching and ordering food products. Due to the excessive amount of time, some foodservice operators may frequently order the same food products from the same food distributor. This may result in foodservice operators overlooking potentially lower prices of the same foods from different distributors.

Therefore, there is a need in the art for systems and methods for providing product relevancy.

### SUMMARY

Systems, methods, and apparatus presented herein each have several innovative aspects, no single one of which is solely responsible for the desirable attributes disclosed herein. The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a system for determining matching products comprises a memory storing instructions and one or more processors coupled with the memory. The one or more processors are configured to: receive, from a user terminal, food product information; transform the food product information into normalized food product information according to a normalized format of a food distribution system; determine a product corresponding to the normalized food product information, wherein the product is associated with one or more normalized first product characteristics; identify a matching product that corresponds to the product based at least on overlap between the one or more normalized first product characteristics and one or more normalized matching product characteristics associated with the matching product; and transmit, to the user terminal, a notification of the matching product.

In another aspect, a computer-implemented method for determining matching products comprises receiving, from a user terminal, food product information, and transforming the food product information into normalized food product information according to a normalized format of a food distribution system. The method further includes determining a product corresponding to the normalized food product information, wherein the product is associated with one or more normalized first product characteristics. Also, the method includes identifying a matching product that corresponds to the product based at least on overlap between the one or more normalized first product characteristics and one or more normalized matching product characteristics associated with the matching product. Further, the method includes transmitting, to the user terminal, a notification of the matching product.

In a further aspect, a non-transitory computer-readable medium stores instructions that are executable by a processor to perform the above-noted method.

In another aspect, a method of performing product relevancy by a discount platform is provided. The method may include receiving, from a user terminal, food product information. The method may include determining whether a product corresponding to the food product information is associated with a discount or a rebate. The method may include transmitting, to the user terminal, a notification of the discount or the rebate, in response to the product being associated with the discount or the rebate. The method may include identifying a matching product that corresponds to the product, wherein the matching product is available for purchase and is associated with a second discount or a second rebate. The method may include transmitting, to the user terminal, a second notification of the matching product.

In another aspect, a method of performing product relevancy by a user terminal is provided. The method may include identifying food product information in website browsing data of a food distributor website displayed by an application of the user terminal. The method may include capturing the website browsing data in response to the food product information being identified. The method may include transmitting, to a discount platform, the website browsing data for determining whether a discount or a rebate corresponds to the food product information.

In other aspects, apparatuses and computer-readable mediums for performing the above-disclosed methods are provided.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The novel features believed to be characteristic of aspects described herein are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative implementations when read in conjunction with the accompanying drawings, wherein:

FIG. 1 is a diagram illustrating an example of a product relevancy system, according to aspects of the present disclosure;

FIG. 2 is a block diagram of a detailed example of the product relevancy system of FIG. 1, according to aspects of the present disclosure;

FIG. 3 is flowchart of an example method of product matching in the system of FIG. 1, according to aspects of the present disclosure;

FIG. 4 is flowchart of an example method performed by a discount engine of the product relevancy system of FIG. 1, according to aspects of the present disclosure;

FIG. 5 is flowchart of an example method performed by a user terminal of the product relevancy system of FIG. 1, according to aspects of the present disclosure;

FIG. 6 is an example system diagram of various hardware components and other features, according to aspects of the present disclosure;

FIG. 7 is a block diagram of various example system components, according to aspects of the present disclosure; and

FIG. 8 is a diagram of example functional components for receiving food product information, transforming the food product information into normalized food product information, and product matching according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Foodservice operators are often tasked with ordering large quantities of food products from distributors by manually searching a number of food product databases of different distributors. Unlike retail products that use a universal product code (UPC), similar food products are described differently by various distributors or manufacturers which may make searching for food products difficult. For example, a product by a first distributor or manufacturer may have a code that is different than the code of an identical (or substantially identical) product by a second distributor or manufacturer. Differences in the description of food products may include, for example, the names of food products, abbreviations of the food products, quantities of the food products, weight of the food products, types and sizes of packaging for the food products, manufacturer identification number (MIN) formats, and pricing. Due to these differences, identifying good quality matches between distributors and foodservice operators may be extremely time consuming and cumbersome for a single individual to perform and may also result in a number of matching food products being missed.

Aspects of the present disclosure are directed towards systems and methods for product relevancy that provide matching food products to a foodservice operator and may provide opportunities for the foodservice operator to save on the cost of food products. In particular, the systems and methods for product relevancy described herein may identify food products that correspond to a food product displayed and/or viewed by the foodservice operator, and may provide recommendations for a less costly, a discounted, or a rebated same or similar food product as compared to the displayed food product.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example variations, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

Turning now to the figures, examples of systems, apparatus, and methods according to aspects of the present disclosure are depicted. It is to be understood that aspects of the figures may not be drawn to scale and are instead drawn for illustrative purposes.

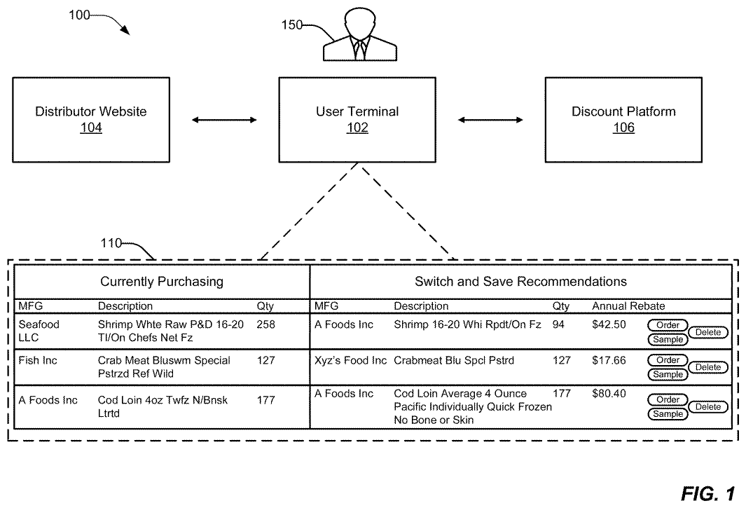

Referring to FIG. 1, a representative block diagram of a product relevancy system 100 includes, for example, user terminal 102 communicatively coupled with a distributor website 104 and a discount platform 106. The product relevancy system 100 may provide, for example, recommendations and/or methods for a foodservice operator 150 using the user terminal 102 to receive lower priced food products. For example, use of the product relevancy system 100 may allow the user terminal 102 to display to the foodservice operator 150 recommendations 110 of different food products based on food products currently being purchased or viewed by the foodservice operator 150, as illustrated by FIG. 1.

The user terminal 102 may include, for example, but is not limited to, a personal computer, a mobile device, a laptop, or a tablet. In an example, the user terminal 102 may communicate with the distributor website 104 and the discount platform 106 via one or more wired or wireless networks such as an intranet, a local area network (LAN), a wide area network (WAN), or the Internet.

Examples of the distributor website 104 may include a website or database providing an electronic method for the foodservice operator 150 to purchase food products.

As described in more detail herein, the discount platform 106 provides a system for matching and providing recommendations for food products to the user terminal 102 based on the food product items from the distributor website 104 viewed by the user terminal 102. Examples of the discount platform 106 may include a server or computer including one or more databases.

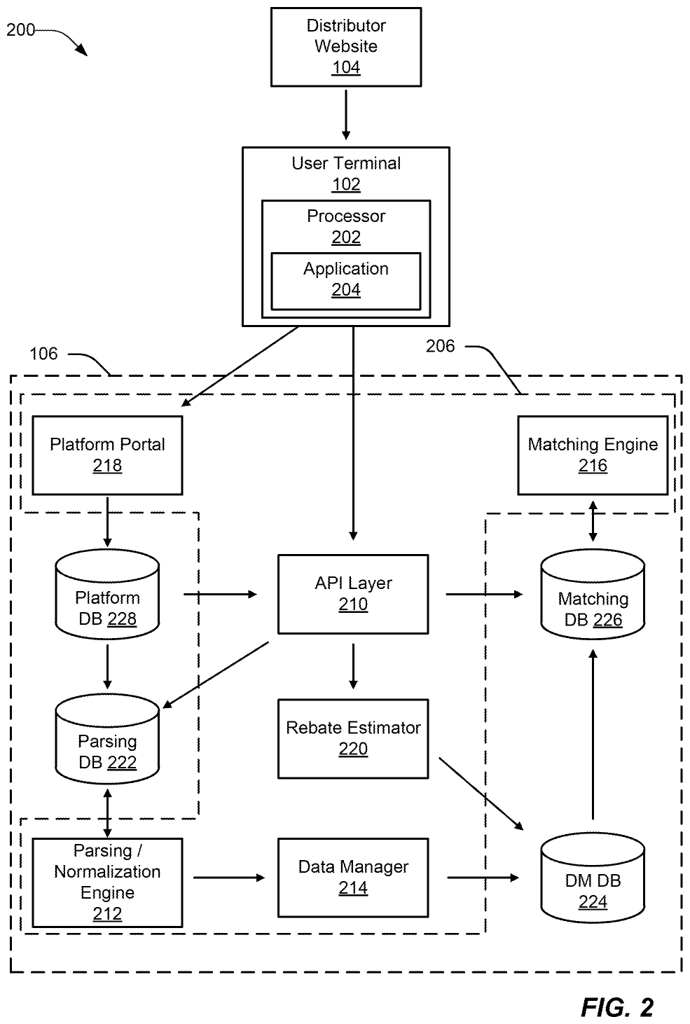

Referring to FIG. 2, a detailed block diagram 200 of an example of the product relevancy system 100 is provided. The user terminal 102 may include, for example, one or more processors 202 that execute an application 204 to interface with the foodservice operator 150 and communicate between the distributor website 104 and the discount platform 106. The application 204 may include, for example, but is not limited to, a browser plug-in, a mobile application, or computer software.

In this example, the application 204 may monitor the distributor website 104 (and/or additional websites or uniform resource locators (URLs)) and/or activity of the foodservice operator 150 at the distributor website for one or more triggers corresponding to food products viewed (e.g., via web browser) and/or being purchased (e.g., placed in purchasing cart) by the foodservice operator 150 on the user terminal 102. Triggers may include, but are not limited to, the application 204 identifying food products placed in a purchasing cart of the distributor website 104 or food products displayed on the distributor website 104 (e.g., hypertext markup language (HTML) indicating food products). For example, when the foodservice provider views or selects an order of “Shrimp Whte Raw P&D 16-20 TI/On Chefs Net Fz” manufactured by “Seafood LLC,” as illustrated by FIG. 1, the application 204 may be triggered to initiate a discount process by communicating with the discount platform 106.

During the discount process, the application 204 may obtain product information on the food products viewed or selected. For example, the application 204 may obtain one or more of an item number (distributor or manufacturer item number) corresponding to the food product, additional details of the food product, such as purchasing limitations, if available, and/or quantity or weight of the product being purchased, if available, via, for example, the browser code (e.g., HTML) of the distributor website 104.

The product information may be sent to the discount platform 106 to determine rebate/discounts for the foodservice operator 150. In an aspect, the discount platform 106 may include one or more processors 206 that communicate with one or more databases, including, for example, a parsing database (interchangeably referred to herein as a parsing DB) 222, a data management database (interchangeably referred to herein as a DM DB) 224, matching database (or matching DB) 226, and platform database (interchangeably referred to herein as a platform DB) 228.

In an example, the one or more processors 206 may include an application programming interface (API) layer 210 which receives the product information from the application 204 and distributes the product information to different engines of the one or more processors 206 and/or the databases. For example, the parsing database 222 may receive product information from the API layer 210 for parsing browser code (e.g., HTML) and determine whether the browser code has been parsed yet. If the browsing code has been parsed, no action is performed. If the browsing code has not been parsed, the browsing code may be forwarded to a parsing/normalization engine 212 of the one or more processors 206.

In an example, the parsing/normalization engine 212 may parse the browsing code into different parts to determine, for example, products offered, costs of the products, description of the products, proof of purchase data, or any additional information corresponding to the products provided by the distributor website 104. The parsing/normalization engine 212 may also send parsed browser code and/or formatted and/or normalized data (e.g., comma separated values (CSV) file) generated through the parsing process to the parsing database 222 for storing and organizing. In an example, the normalized data may include information, such as description of products, formatted for comparison to other products.

Further, the parsing/normalization engine 212 may send normalized data to a data manager 214 of the one or more processors 206. The data manager 214, in combination with the data manager database 224 may be a centralized location for normalized data containing a list of products having rebates/discounts from different distributors and manufactures. In an example, the data manager database 224 organizes and stores information pertaining to all known products and discounts/rebates.

In an aspect, the one or more processors 206 may also include a matching engine 216 configured to receive product information from the matching database 226 and procure information on discounts/rebates of similar products. In an example, the matching engine 216 may continuously look for and obtain the information. For example, the matching engine 216 may receive new product information from the matching database 226 and search for another product with, for example, a similar product description, quantity, availability, or any other characteristics that would identify a match of the products. The matching engine 216 may also constantly update matching information of other products by continuously searching for more or updating stored matching information. The matching database 226 may store a list of products and correlate different characteristics of the product to matching products. In an example, matching products may include similar food products (e.g., shrimp) with similar descriptions (e.g., quantity, size, weight).

In an aspect, the one or more processors 206 may also include a platform portal 218 configured to perform user onboarding to assist the foodservice operator 150 through the discount process. In an example, the platform portal 218 may obtain user identifying data corresponding to the foodservice operator 150 from the application 204. The user identifying data may be sent to the platform database 228 for comparison to stored profile data for all foodservice providers managed by the discount platform 106, and user information such as food preferences may be sent to the API layer 210 and used during a discount process.

In an aspect, the API layer 210 may be configured to verify whether there is a rebate/discount available for a given product. For example, the API layer 210 may send the product information to a rebate estimator 220 of the one or more processors 206 for determining the availability of a rebate/discount. The rebate estimator 220 may verify with the data manager database 224 whether the rebate/discount is available. If the product information corresponds to a rebate/discount, the rebate estimator 220 notifies the API layer 210, which in return notifies the application 204 of the rebate/discount. In an example, the notification may indicate to the foodservice operator 150 that the product associated with the product information includes a rebate. Regardless of whether or not there is a rebate/discount associated with the product information, the rebate estimator 220 notifies the API layer 210, and the API layer 210 communicates with the matching database 226 to determine whether a matching product has an associated discount/rebate. If so, a notification may be provided to the foodservice operator 150 that the matching product also has an associated discount. The process may continue until a predetermined threshold has been reached, e.g., five or ten (or any other number) matching products have been reviewed.

While examples of the application 204 have been described herein as hardware/software being used for viewing or purchasing food products from the distributor website 104, aspects of the present disclosure are not limited to this example. Instead, these examples may apply to hardware/software that monitors the viewing or purchasing of food products on other hardware/software, for example, as in the case of a browser plug-in.

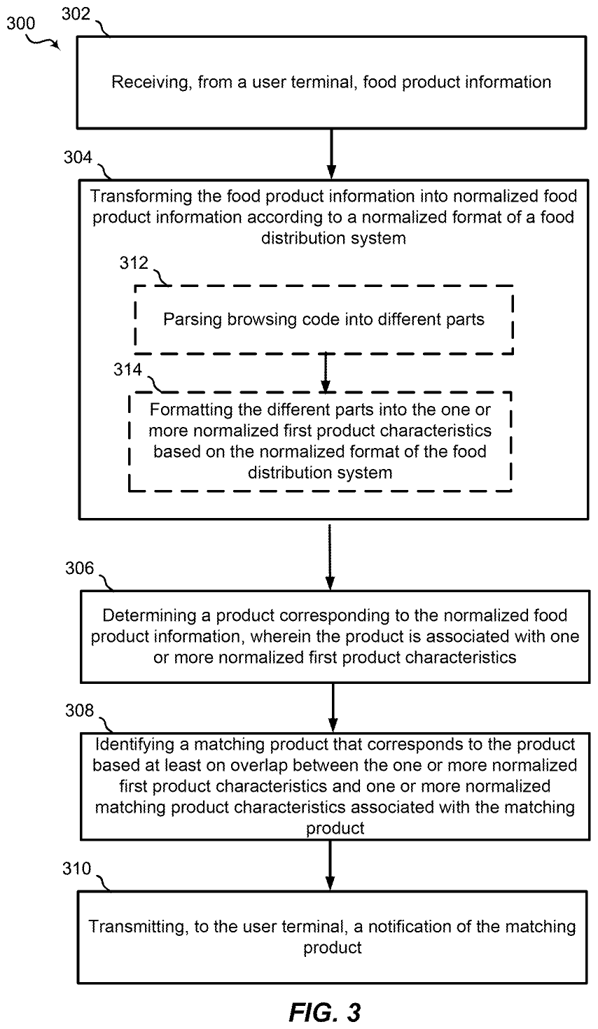

Referring to FIG. 3, in an aspect, a computer-implemented method 300 for determining matching products may be performed by the product relevancy system 100. For example, operations of the method 300 may be performed by one or more components of the discount platform 106 including, for example, the one or more processors 206 and/or the databases (e.g., databases 222-228).

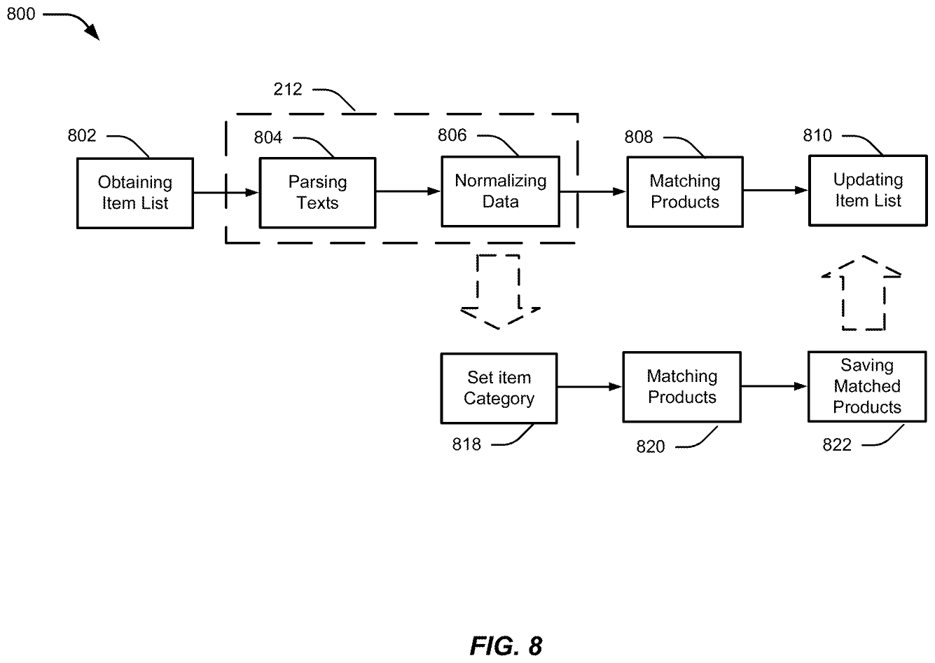

At block 302, the method 300 includes receiving, from a user terminal, food product information. For example, the one or more processors 206 and/or the API layer 210 may receive, from the user terminal 102, food product information. In an example, the food product information may be received from a foodservice operator 150, and may include, for example, a name of a product, a description of the product, a DIN or MIN of the product, or any other identifying information corresponding to the product. Further the food product information may include web browsing code (e.g., HTML). Additional aspects relating to receiving the food product information are described below with reference to FIG. 8.

At block 304, the method 300 includes transforming the food product information into normalized food product information according to a normalized format of a food distribution system. For example, the one or more processors 206 and/or the API layer 210 may transform the food product information into normalized food product information according to a normalized format of a food distribution system, as described herein. Additional aspects relating to transforming the food product information into normalized food product information are described below with regard to blocks 312 and 314, and also in reference to FIG. 8.

At block 306, the method 300 includes determining a product corresponding to the normalized food product information, wherein the product is associated with one or more normalized first product characteristics. For example, the one or more processors 206 and/or the API layer 210 may determine a product corresponding to the normalized food product information, wherein the product is associated with one or more normalized first product characteristics, as described herein.

At block 308, the method 300 includes identifying a matching product that corresponds to the product based at least on overlap between the one or more normalized first product characteristics and one or more normalized matching product characteristics associated with the matching product. For example, the one or more processors 206 and/or the API layer 210 may identify a matching product that corresponds to the product based at least on overlap between the one or more normalized first product characteristics and one or more normalized matching product characteristics associated with the matching product, as described herein.

At block 310, the method 300 includes transmitting, to the user terminal, a notification of the matching product. For example, the one or more processors 206 and/or the API layer 210 may transmit, to the user terminal, a notification of the matching product to be viewed by operator of the user terminal, e.g., the foodservice operator 150, as described herein.

In an alternative or additional aspect, at block 312, wherein the food product information is received as browsing code, the transforming of the food product information at block 304 into normalized food product information further comprises parsing browsing code into different parts.

Additionally, in this alternative or additional aspect, at block 314, the method 300 may further include formatting the different parts into the one or more normalized first product characteristics based on the normalized format of the food distribution system.

Additionally aspects relating to the parsing of block 312 and the formatting of block 314 are described below in reference to FIG. 8.

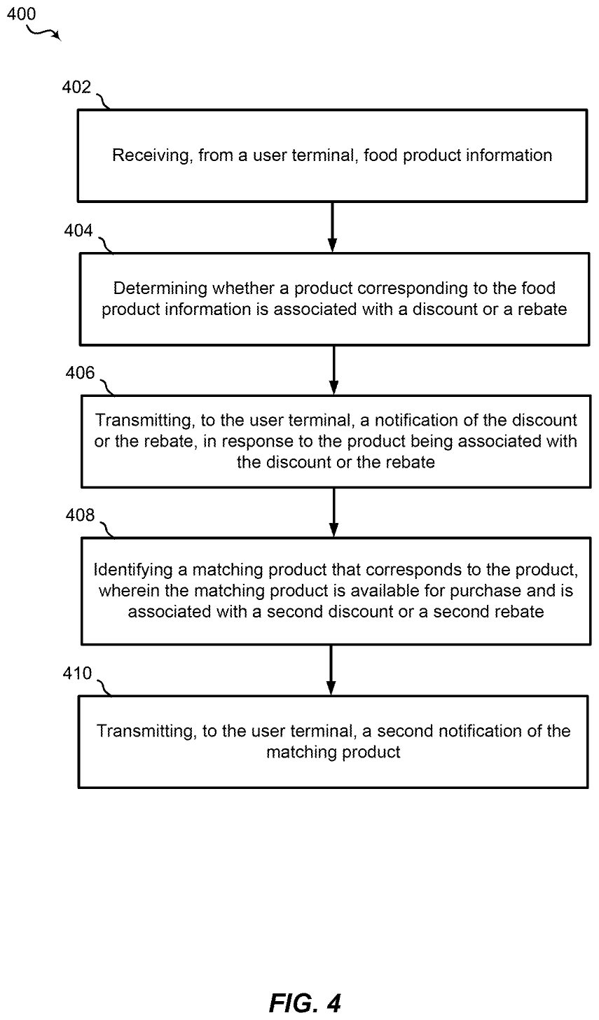

Referring to FIG. 4, an example of a method 400 for performing a purchasing relevancy process may be performed by the product relevancy system 100. For example, operations of the method 400 may be performed by one or more components of the discount platform 106 including, for example, the one or more processors 206 and/or the databases (e.g., databases 222-228).

At block 402, the method 400 may include receiving, from a user terminal, food product information. For example, the one or more processors 206 and/or the API layer 210 may receive, from the user terminal 102, food product information. In an example, the food product may include, for example, a name of a product, a description of the product, a DIN or MIN of the product, or any other identifying information corresponding to the product. Further the food product information may include web browsing code (e.g., HTML).

At block 404, the method 400 may include determining whether a product corresponding to the food product information is associated with a discount or a rebate. For example, the one or more processors 206, the API layer 210, the rebate estimator 220, and/or the data manager database 224 may determine whether a product corresponding to the food product information is associated with a discount or a rebate. In an example, the rebate estimator 220 may check the data manager database 224 whether information on the product already correlates to a discount/rebate.

At block 406, the method 400 may include transmitting, to the user terminal, a notification of the discount or the rebate, in response to the product being associated with the discount or the rebate. For example, the one or more processors 206 and/or the API layer 210 may transmit, to the user terminal 102, a notification (e.g., recommendations 110) of the discount or the rebate, in response to the product being associated with the discount or the rebate.

At block 408, the method 400 may include identifying a matching product that corresponds to the product, wherein the matching product is available for purchase and is associated with a second discount or a second rebate. For example, the one or more processors 206, the API layer 210, the matching engine 216, and/or the matching database 226 may identify a matching product that corresponds to the product. In an example, the API layer 210 may verify with the matching database 226 whether the matching product exists. Additionally, the matching database 226 may communicate with the matching engine 216 to have the matching engine 216 search for and provide, if available, the matching product by performing, for example, a web search of one or more food distributor and/or food manufacturer websites. In some examples, the matching product that corresponds to the product is identified in response to the product not being associated with the discount or the rebate.

At block 410, the method 400 may include transmitting, to the user terminal, a second notification of the matching product. For example, the one or more processors 206 and/or the API layer 210 may transmit, to the user terminal 102, a second notification (e.g., recommendations 110 of FIG. 1) of the matching product. The process may continue until a predetermined threshold has been reached, e.g., five or ten (or any other number) matching products have been reviewed.

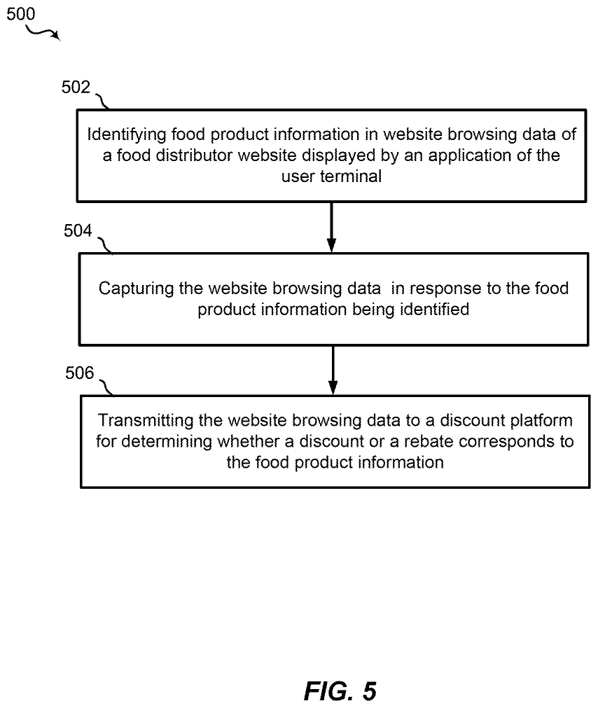

Referring to FIG. 5, an example of a method 500 for performing a purchasing relevancy process may be performed by the product relevancy system 100. For example, operations of the method 500 may be performed by one or more components of the user terminal 102 including, for example, the processor 202 of FIG. 2 and/or the application 204 of FIG. 2.

At block 502, the method 500 may include identifying food product information in website browsing data viewed on an application of the user terminal. For example, the user terminal 102, the one or more processors 202 and/or the application 204 may identify food product information in website browsing data corresponding to the distributor website 104 displayed by the application 204 of the user terminal 102.

At block 504, the method 500 may include capturing the website browsing data in response to the food product information being identified. For example, the user terminal 102, the one or more processors 202, and/or the application 204 may capture the website browsing data (e.g., HTML) corresponding to the distributor website 104 in response to the food product information being identified.

At block 506, the method 500 may include transmitting, to a discount platform, the website browsing data for determining whether a discount or a rebate corresponds to the food product information. For example, the one or more processors 206 and/or the API layer 210 may transmit, to a discount platform, the website browsing data for determining whether a discount or a rebate corresponds to the food product information.

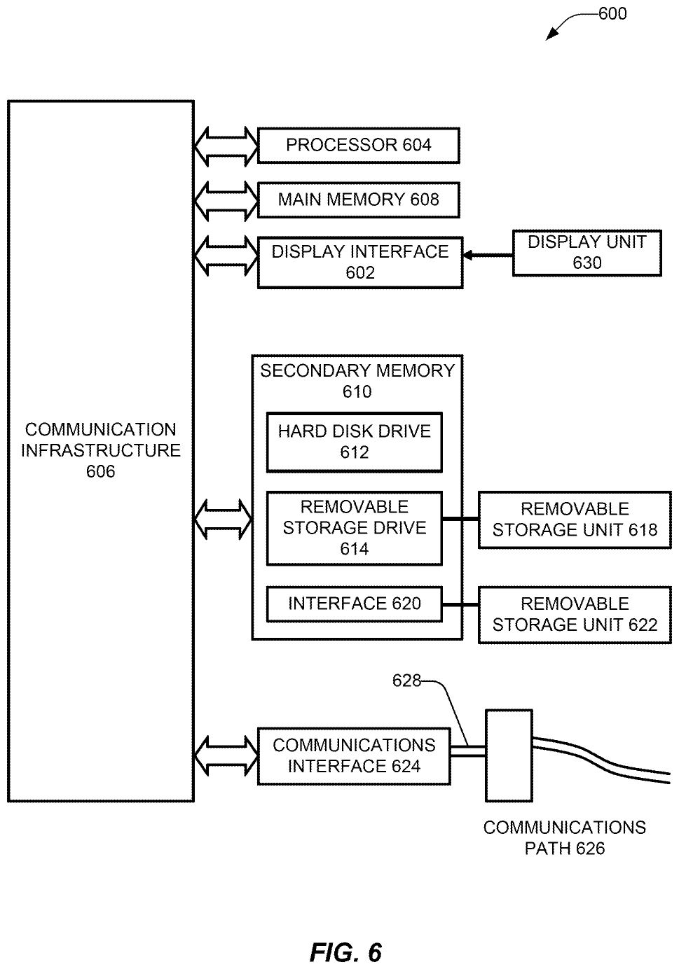

Referring to FIG. 6, an example system is presented with a diagram of various hardware components and other features, for use in accordance with an aspect of the present disclosure. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system 600 is shown in FIG. 6. In an aspect, the user terminal 102 or the discount platform 106 of FIG. 1 may be implemented using the computer system 600.

The computer system 600 may include one or more processors, such as processor 604. The one or more processors 202 or 206 of FIG. 2 may be examples of the processor 604. The processor 604 may be connected to a communication infrastructure 606 (e.g., a communications bus, cross-over bar, or network). Various software aspects are described in terms of this example computer system 600. After reading this description, it will become apparent to a person skilled in the relevant art(s) how to implement aspects described herein using other computer systems and/or architectures.

The computer system 600 may include a display interface 602 that forwards graphics, text, and other data from the communication infrastructure 606 (or from a frame buffer not shown) for display on a display unit 630. The computer system 600 may also include a main memory 608, e.g., random access memory (RAM), and may also include a secondary memory 610. The secondary memory 610 may include, e.g., a hard disk drive 612 and/or a removable storage drive 614, representing a floppy disk drive, a magnetic tape drive, an optical disk drive, etc. The removable storage drive 614 may read from and/or write to a removable storage unit 618 in a well-known manner. The removable storage unit 618, represents a floppy disk, magnetic tape, optical disk, etc., which is read by and written to the removable storage drive 614. As will be appreciated, the removable storage unit 618 may include a computer usable storage medium having stored therein computer software and/or data.

In alternative aspects, the secondary memory 610 may include other similar devices for allowing computer programs or other instructions to be loaded into the computer system 600. Such devices may include, e.g., a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to the computer system 600.

The computer system 600 may also include a communications interface 624. The communications interface 624 may allow software and data to be transferred between the computer system 600 and external devices. Examples of the communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by the communications interface 624. These signals 628 are provided to the communications interface 624 via a communications path (e.g., channel) 626. This path 626 carries signals 628 and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals 628. These computer program products provide software to the computer system 600. Aspects described herein may be directed to such computer program products.

Computer programs (also referred to as computer control logic or applications (e.g., application 204 of FIG. 2)) may be stored in the main memory 608 and/or the secondary memory 610. The computer programs may also be received via the communications interface 624. Such computer programs, when executed, enable the computer system 600 to perform various features in accordance with aspects described herein. In particular, the computer programs, when executed, enable the processor 604 to perform such features. Accordingly, such computer programs represent controllers of the computer system 600. The computer programs may include instructions or code for executing methods described herein.

In variations where aspects described herein are implemented using software, the software may be stored in a computer program product and loaded into the computer system 600 using the removable storage drive 614, the hard disk drive 612, or the communications interface 620. The control logic (software), when executed by the processor 604, causes the processor 604 to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

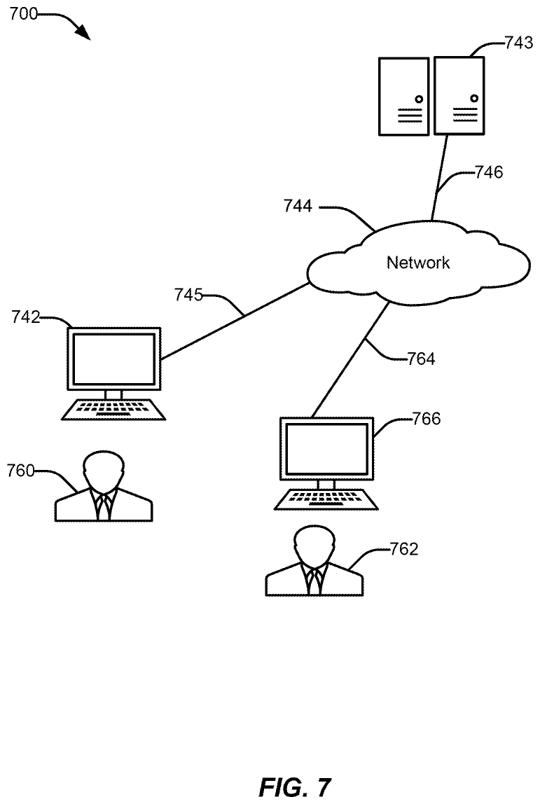

FIG. 7 is a block diagram of various example system components. FIG. 7 shows a communication system 700 including one or more accessors 760, 762 (also referred to interchangeably herein as one or more “users” or foodservice operator 150) and one or more terminals 742, 766. The terminals 742, 766 may include the user terminal 102 or a related system, and/or the like. In one aspect, data for use in accordance with aspects described herein may be input and/or accessed by the accessors 760, 762 via the terminals 742, 766, such as personal computers (PCs), minicomputers, mainframe computers, microcomputers, telephonic devices, or wireless devices, such as personal digital assistants (“PDAs”) or a hand-held wireless devices coupled with a server 743, such as a PC, minicomputer, mainframe computer, microcomputer, or other device having a processor and a repository for data and/or connection to a repository for data. The discount platform 106 may be an example of the server 743.

The terminals 742, 766 may couple with the server 743 via, for example, a network 744 for instance, such as the Internet or an intranet, and couplings 745, 746, 764. The couplings 745, 746, 764 may include wired, wireless, or fiberoptic links. In another example variation, the method and system in accordance with aspects described herein operate in a stand-alone environment, such as on a single terminal.

FIG. 8 a diagram of example functional components for receiving food product information, transforming the food product information into normalized food product information, and performing product matching. Referring to FIGS. 2, 3, and 8, in a diagram 800 at 802, an item list is obtained. For example, the discount platform 106 and/or the API layer 210 may obtain food product information including an item list from the foodservice operator 150. The item list may include products offered by a distributor and/or a manufacturer. In some implementations, the item list may include grocery items. In one example, which should not be construed as limiting, the grocery item may have an associated string of “Chk brst fz brd 6 oz 4/6 lb $48 case distr manuf.” The item list may be an online list in HTML.

Next, at 804, the item list may be parsed to identify different elements. For example, the discount platform 106, the parsing DB 222, and/or the parsing/normalization engine 212 may parse the strings of items on the item list. In some aspects, the discount platform 106 may parse the strings to extract one or more keywords from the strings. The parsing may include identifying words, symbols, numbers, abbreviations, acronyms, alphabets, or other characters in the strings and converting the strings to words/symbols that the discount platform 106 may utilize for performing logic operations. For instance, in one implementation, which should not be construed as limiting, the parsing may identify portions of the item list relating to a product description, a pack size, a price, a distributor, and a manufacturer, among other parameters. For example, the parsing/normalization engine 212 may parse the string using one or more parsing functions, such as but not limited to one or more selectors that can select elements on an HTML page (e.g., CCS selectors). The string of “Chk brst fz brd 6 oz 4/6 lb $48 case distr manuf” may be parsed as separate elements such as “Chk brst fz brd 6 oz” relating to a product description, “4/6 lb” relating to a package size and/or product weight, “$48 case” relating to a price, “dist” relating to an identifier of a distributor, and “manf” relating to an identifier of a manufacturer. “Chicken breast frozen breaded; 4: outer pack; 6: inner pack; and oz: pack unit of measure.” Further, the parsing/normalization engine 212 may parse the distributor from the characters “distr” and the manufacturer from the characters “manuf.”

At 806, the parsed data is normalized. For example, the discount platform 106, the parsing DB 222, and/or the parsing/normalization engine 212 may identify normalized data after parsing the strings associated with the items on the item list. The discount platform 106, the parsing DB 222, and/or the parsing/normalization engine 212 may execute one or more of a description algorithm, a pack size algorithm, a price algorithm to extract normalized data from the strings. In one example, the discount platform 106, the parsing DB 222, and/or the parsing/normalization engine 212 may identify one or more normalized data from the parsed string of “Chk brst fz brd 6 oz 4/6 lb $48 case distr manuf.” For instance, the discount platform 106, the parsing DB 222, and/or the parsing/normalization engine 212 may identify the parsed element “Chk brst fz brd 6 oz” as a normalized product description such as “Chicken breast frozen breaded” or “chicken,” the parsed element of “4/6 lb” as a normalized pack size of “4: outer pack” and “6: inner pack,” the parsed element of “6 oz” as a normalized product unit as “ounce,” the parsed element of “$48 case” (in combination with 4 packs of 6 identifying 24 units) as a normalized unit price of $2 per Ib, the parsed “dist” information as a normalized distributor name and/or unique distributor identifier (e.g., DI-1234567), and/or the parsed “manf” information as a normalized manufacturer name and/or unique manufacture identifier (e.g., MA-1234567).

At 808, one or more matching processes are performed to try to find products in the database that are the same as or similar to the normalized item information, e.g., to find one or more matching products. For example, the discount platform 106, the matching engine 216, and/or the matching DB 226 may compare the items using normalized item data and/or machine learning that computes the matches, such as via one or more word comparison algorithms. For instance, the discount platform 106, the matching engine 216, and/or the matching DB 226 may compare the item associated with the string of “Chk brst fz brd 6 oz 4/6 lb $48 case distr manuf” with existing items in the matching DB 226. For example, the discount platform 106, the matching engine 216, and/or the matching DB 226 may compare the normalized item, e.g., “Chicken breast frozen breaded” or “chicken,” with other chickens, frozen chickens, breaded chickens, frozen breaded chickens, etc., to determine whether there are desirable alternatives (e.g., costing less than $2 per Ib).

At 810, the item list is updated to present any matches that are found. For example, the discount platform 106, the platform portal 218, the platform DB 228, and/or the data manager 214 may update item lists based on available and/or desirable substitute items. In some instances, new items, new rebates, and/or new matched items may be added to the item lists. The discount platform 106 may update new pricings for existing items. The discount platform 106 may replace one or more items on the item lists with substitute items that cost less per unit. The discount platform 106 may replace one or more items with substitute items that satisfy certain criteria of the food service operator 150 (e.g., lower price, faster delivery, available in larger quantities, lower delivery fees, longer shelf-life, etc.). The discount platform 106 may display updated item lists via the application 204. For example, the discount platform 106 may update webpages with HTML injections.

In one optional or additional aspect of the present disclosure, at 818, after normalizing the data, the item may be categorized. For example, the discount platform 106, the parsing/normalization engine 212, the parsing DB 222, the matching engine 216, and/or the matching DB 226 are configured to set an item category of the items on the item list. After parsing and normalizing the string associated with an item, the discount platform 106 may identify a category associated with the item based on the parsed and normalized string. Each item may be categorized under one or more categories. As an example, a category may identify a type of a food item. For example, an item with a string of “Chk brst fz brd 6 oz 4/6 lb $48 case distr manuf” may be categorized under a “poultry” category, a “frozen breaded chicken breast” category, a “breaded chicken breast” category, a “frozen chicken breast” category, a “chicken breast” category, and/or a “chicken” category.

In some optional or additional aspects of the present disclosure, at 820, the matching products within each category are determined and compared to identify possible alternatives and/or less expensive options. For example, the discount platform 106, the matching engine 216, and/or the matching DB 226 may compare items in the item list with items in the respective categories. A string comparison algorithm may be used to compare the normalized strings of product descriptions to identify matching items, and then, for example, their normalized price may be compared to identify less costly options. For example, the item with the original string of “Chk brst fz brd 6 oz 4/6 lb $48 case distr manuf,” with the normalized price of $2 per lb may be compared with another item in the matching DB 226 having a normalized price of $1.5 per lb (e.g., having a string of “Chk brst fz 6 oz 2/10 lb $30,” which is normalized to $1.5 per lb of frozen chicken breast 2: outer pack 10: inner pack oz: pack unit of measure.”).

In some aspects, at 822, the matched products are saved and used to update the item list (such as at 810). For example, the discount platform 106, the matching engine 216, and/or the matching DB 226 may save the matched products in the matching DB 226. For example, the item identified as $1.5 per lb of frozen chicken breast may be saved as a match to the item identified as $2 per lb of frozen breaded chicken breast.

Aspects of the present disclosure include a computer-implemented method, a system, and/or a non-transitory computer readable medium for determining matching products including receiving, from a user terminal, food product information, transforming the food product information into normalized food product information according to a normalized format of a food distribution system, determining a product corresponding to the normalized food product information, wherein the product is associated with one or more normalized first product characteristics, identifying a matching product that corresponds to the product based at least on overlap between the one or more normalized first product characteristics and one or more normalized matching product characteristics associated with the matching product, and transmitting, to the user terminal, a notification of the matching product.

Aspects of the present disclosure includes the computer-implemented method, system, and/or non-transitory computer readable medium above, wherein the food product information is received as browsing code, and wherein transforming the food product information into normalized food product information further comprises parsing browsing code into different parts, and formatting the different parts into the one or more normalized first product characteristics based on the normalized format of the food distribution system.

Aspects of the present disclosure includes the computer-implemented method, system, and/or non-transitory computer readable medium above, further including determining whether a product corresponding to the food product information is associated with a first discount or a first rebate, transmitting, to the user terminal, a first notification of the first discount or the first rebate, in response to the product being associated with the first discount or the first rebate, determining that the matching product is available for purchase and is associated with a second discount or a second rebate, and transmitting, to the user terminal, a second notification of the matching product and the second discount or the second rebate.

Aspects of the present disclosure includes the computer-implemented method, system, and/or non-transitory computer readable medium above, wherein identifying a matching product that corresponds to the product further comprises comparing the normalized food product information to a database of food product information that is normalized for searching and corresponds to discounts and rebates offered by food manufacturers or food distributors.

Aspects of the present disclosure includes the computer-implemented method, system, and/or non-transitory computer readable medium above, wherein the matching product is a respective product in the database having one or more of a same name as the product, a same word in a description of the product, or a same quantity as the product.

Aspects of the present disclosure includes the computer-implemented method, system, and/or non-transitory computer readable medium above, wherein the food product information is received as one or more strings, and wherein to transform the food product information into normalized food product information the one or more processors are further configured to parse a string of the one or more strings into a plurality of substrings, identify a plurality of keywords each associated one of the plurality of substrings, normalize the food product information into a normalized string that includes at least one of a normalized product description, a normalized pack size, or a normalized unit price.

Aspects of the present disclosure includes the computer-implemented method, system, and/or non-transitory computer readable medium above, wherein identifying the matching product that corresponds to the product comprises performing a string comparison between the normalized string and a first normalized string associated with the matching product.

Aspects of the present disclosure includes the computer-implemented method, system, and/or non-transitory computer readable medium above, wherein one or more of the first notification or the second notification includes display information for the user terminal to display.

Aspects of the present disclosure includes the computer-implemented method, system, and/or non-transitory computer readable medium above, wherein the matching product that corresponds to the product is identified in response to the product not being associated with a discount or a rebate.

The aspects discussed herein may also be described and implemented in the context of computer-readable storage medium storing computer-executable instructions. Computer-readable storage media includes computer storage media and communication media, and may be, flash memory drives, digital versatile discs (DVDs), compact discs (CDs), floppy disks, and tape cassettes. Computer-readable storage media may include volatile and nonvolatile, removable and non-removable media implemented in any method or technology for storage of information such as computer readable instructions, data structures, modules or other data.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A system for determining matching products, comprising:
a memory storing instructions; and
one or more processors coupled with the memory and configured to:
receive, from a user terminal, food product information;
transform the food product information into normalized food product information according to a normalized format of a food distribution system;
determine a product corresponding to the normalized food product information, wherein the product is associated with one or more normalized first product characteristics;
identify a matching product that corresponds to the product based at least on overlap between the one or more normalized first product characteristics and one or more normalized matching product characteristics associated with the matching product; and
transmit, to the user terminal, a notification of the matching product.

2. The system of claim 1, wherein the food product information is received as browsing code, and wherein to transform the food product information into normalized food product information the one or more processors are further configured to:
parse browsing code into different parts; and
format the different parts into the one or more normalized first product characteristics based on the normalized format of the food distribution system.

3. The system of claim 1, wherein the one or more processors are further configured to:
determine whether a product corresponding to the food product information is associated with a first discount or a first rebate;
transmit, to the user terminal, a first notification of the first discount or the first rebate, in response to the product being associated with the first discount or the first rebate;
determine that the matching product is available for purchase and is associated with a second discount or a second rebate; and
transmit, to the user terminal, a second notification of the matching product and the second discount or the second rebate.

4. The system of claim 1, wherein to identify a matching product that corresponds to the product the one or more processors are further configured to:
compare the normalized food product information to a database of food product information that is normalized for searching and corresponds to discounts and rebates offered by food manufacturers or food distributors.

5. The system of claim 4, wherein the matching product is a respective product in the database having one or more of a same name as the product, a same word in a description of the product, or a same quantity as the product.

6. The system of claim 1, wherein the food product information is received as one or more strings, and wherein to transform the food product information into normalized food product information the one or more processors are further configured to:
parse a string of the one or more strings into a plurality of substrings;
identify a plurality of keywords each associated one of the plurality of substrings;
normalize the food product information into a normalized string that includes at least one of a normalized product description, a normalized pack size, or a normalized unit price.

7. The system of claim 6, wherein identifying the matching product that corresponds to the product comprises:
performing a string comparison between the normalized string and a first normalized string associated with the matching product.

8. The system of claim 3, wherein one or more of the first notification or the second notification includes display information for the user terminal to display.

9. The system of claim 1, wherein the matching product that corresponds to the product is identified in response to the product not being associated with a discount or a rebate.

10. A computer-implemented method for determining matching products, comprising:
receiving, from a user terminal, food product information;
transforming the food product information into normalized food product information according to a normalized format of a food distribution system;
determining a product corresponding to the normalized food product information, wherein the product is associated with one or more normalized first product characteristics;
identifying a matching product that corresponds to the product based at least on overlap between the one or more normalized first product characteristics and one or more normalized matching product characteristics associated with the matching product; and
transmitting, to the user terminal, a notification of the matching product.

11. The method of claim 10, wherein the food product information is received as browsing code, and wherein transforming the food product information into normalized food product information further comprises:
parsing browsing code into different parts; and
formatting the different parts into the one or more normalized first product characteristics based on the normalized format of the food distribution system.

12. The method of claim 10, further comprising:
determining whether a product corresponding to the food product information is associated with a first discount or a first rebate;
transmitting, to the user terminal, a first notification of the first discount or the first rebate, in response to the product being associated with the first discount or the first rebate;
determining that the matching product is available for purchase and is associated with a second discount or a second rebate; and
transmitting, to the user terminal, a second notification of the matching product and the second discount or the second rebate.

13. The method of claim 10, wherein identifying a matching product that corresponds to the product further comprises:
comparing the normalized food product information to a database of food product information that is normalized for searching and corresponds to discounts and rebates offered by food manufacturers or food distributors.

14. The method of claim 13, wherein the matching product is a respective product in the database having one or more of a same name as the product, a same word in a description of the product, or a same quantity as the product.

15. The method of claim 10, wherein the food product information is received as one or more strings, and wherein to transform the food product information into normalized food product information the one or more processors are further configured to:
parse a string of the one or more strings into a plurality of substrings;
identify a plurality of keywords each associated one of the plurality of substrings;
normalize the food product information into a normalized string that includes at least one of a normalized product description, a normalized pack size, or a normalized unit price.

16. The method of claim 15, wherein identifying the matching product that corresponds to the product comprises:
performing a string comparison between the normalized string and a first normalized string associated with the matching product.

17. The method of claim 12, wherein one or more of the first notification or the second notification includes display information for the user terminal to display.

18. The method of claim 10, wherein the matching product that corresponds to the product is identified in response to the product not being associated with a discount or a rebate.

19. A non-transitory computer-readable medium storing instructions for determining matching products, wherein the instructions are executable by a processor to:
receive, from a user terminal, food product information;
transform the food product information into normalized food product information according to a normalized format of a food distribution system;
determine a product corresponding to the normalized food product information, wherein the product is associated with one or more normalized first product characteristics;
identify a matching product that corresponds to the product based at least on overlap between the one or more normalized first product characteristics and one or more normalized matching product characteristics associated with the matching product; and
transmit, to the user terminal, a notification of the matching product.
